(19) United States
(12) Patent Application Publication
(10) Pub. No.: US 2011/0266355 A1
(43) Pub. Date: Nov. 3, 2011

(54) WATER MIXER FOR FAUCET

(76) Inventor: TSAI-CHEN YANG, Taichung City (TW)

(21) Appl. No.: 12/770,596

(22) Filed: Apr. 29, 2010

(51) Int. Cl. G05D 23/13

(52) U.S. Cl. 236/12.15

(57) ABSTRACT

A water mixer of the present invention is adapted to be installed in a faucet. The water mixer has a balance unit and a mixing element, and the water mixer can be connected to two water sources. When the pressure of one water source varies rapidly, the balance element can modulate the effect that may influence the flow rate of each water source. The mixing element is, on the other hand, adapted to mix the two water flows. As such, the faucet provided with the water mixer of the present invention can stabilize the temperature of the mixed water outlet.

### BACKGROUND OF THE INVENTION

1. Field of the Invention

The present invention relates to a water mixer, and more particularly to a water mixer installed in a faucet to control the mixing of two water flows.

2. Description of the Prior Art

A conventional faucet may be provided with a mixing property to mix two water flows, e.g. a hot water flow and a cold water flow. However, the temperature of the mixed water sometimes changes suddenly when the water pressure of one of the water sources drops. Thus the conventional faucet is a potential threat to the user in that the user may be scalded.

The present invention is, therefore, arisen to obviate or at least mitigate the above mentioned disadvantages.

### SUMMARY OF THE INVENTION

The main object of the present invention is to provide a water mixer that can balance the flow rate of two water flows.

To achieve the above and other objects, a water mixer of the present invention includes a shell, a balance element, a mixing element and an adjusting element. The shell has a transversal plate, which has a first surface and a second surface. A first chamber is defined between the first surface and the shell. A second chamber and a third chamber is defined between the second surface and the shell. The transversal plate is formed with a first passage and a second passage, both of which communicate the first chamber with the second chamber. The third chamber is isolated from the second chamber, and the third chamber is communicated with the first chamber. The balance element includes a first tube unit, a second tube unit and a pressure balancer. The tube units are disposed in the second chamber. The first tube unit has a through hole communicated with the first passage, and the second tube unit has a through hole communicated with the second passage. Each tube unit has a lateral bore communicated with its through hole. The lateral bores of the tube units face each other. A receiving space is defined between the lateral bores. The pressure balancer is movably disposed in the receiving space. The mixing element is disposed in the first chamber. The mixing element is adapted to regulate water to enter the first chamber via the first and second passages and to regulate the water in the first chamber to flow to the third chamber. The adjusting element connects to the mixing element. The adjusting element is adapted to control a movement of the mixing element so as to further adjust a mixing ratio of a flow rate in the first passage to a flow rate in the second passage.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a water mixer in accordance with a first preferred embodiment of the present invention;

FIG. 2 is a partial breakdown drawing showing a water mixer in accordance with a first preferred embodiment of the present invention;

FIG. 3 is a breakdown drawing showing a water mixer in accordance with a first preferred embodiment of the present invention;

FIG. 3A is a top view showing a shell in accordance with a first preferred embodiment of the present invention;

FIG. 3B is a perspective drawing showing a shell in accordance with a first preferred embodiment of the present invention;

FIG. 3C is a perspective drawing showing a tube unit of the present invention;

FIG. 4 is a profile showing a water mixer in accordance with a first preferred embodiment of the present invention;

FIG. 5 is a top view showing a status of a water mixer in accordance with a first preferred embodiment of the present invention;

FIG. 6 is a top view showing another status of a water mixer in accordance with a first preferred embodiment of the present invention;

FIG. 7 is a breakdown drawing showing a water mixer in accordance with a second preferred embodiment of the present invention.

### DETAILED DESCRIPTION OF THE PREFERRED EMBODIMENTS

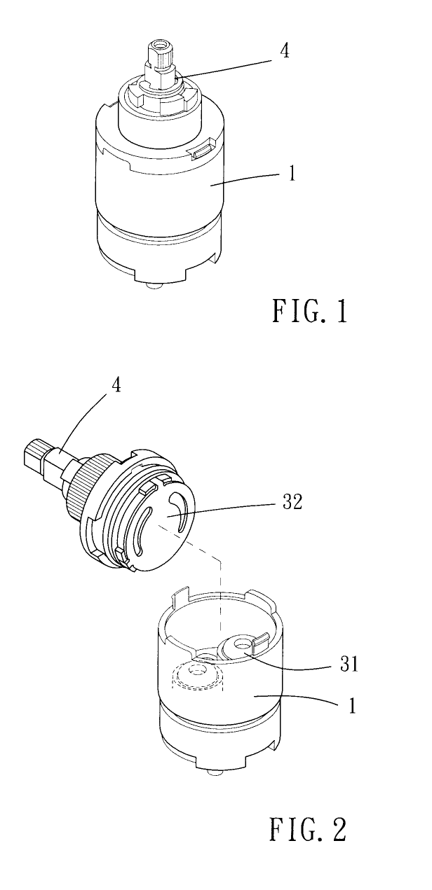

Please refer to FIG. 1 to FIG. 3. A water mixer of the present invention is adapted to be installed in a faucet, and the water mixer includes a shell 1, a balance element 2, a mixing element 3 and an adjusting element 4.

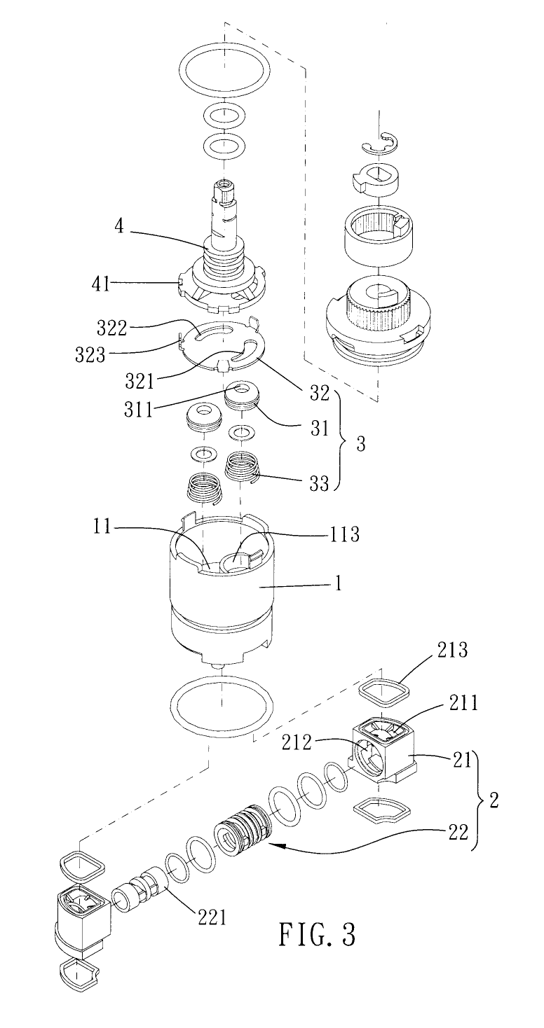

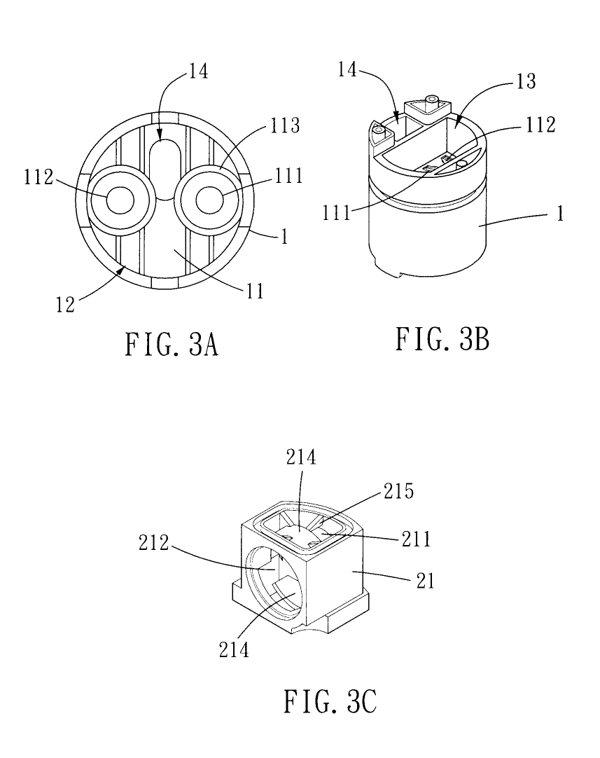

The shell 1 may be an integral-formed cylindrical body. Please refer to FIG. 3A and FIG. 3B. The shell 1 has transversal plate 11 which is perpendicular to the axial direction of the shell 1. The shell has a first surface and a second surface. A first chamber 12 is defined between the first surface and the shell 1. A second chamber 13 and a third chamber 14 are defined between the second surface and the shell 1, in which the third chamber 14 is isolated from the second chamber 13. The transversal plate 11 is formed with a first passage 111 and a second passage 112, both of which communicate the first chamber 12 with the second chamber 13. Two annular rims 113 are axially extended from the first surface of the transversal plate 11, and the annular rims 113 surround one of the first and second passages 111 and 112 respectively. In addition, the third chamber 14 is communicated with the first chamber 12 via a channel formed on the transversal plate 11.

Please refer to FIG. 3. The balance element 2 includes two tube units 21 and a pressure balancer 22. The tube units 21 are disposed in the second chamber 13 and abut against the shell 1 at their outer surfaces. Each tube unit 21 has a through hole 211 communicated with one of the passages 111 and 112. Each tube unit 21 further has a lateral bore 212 communicated with its through hole 211. The lateral bores 212 of the tube units 21 face each other, and a receiving space is defined between the lateral bores 212 for the pressure balancer 22 to movably dispose therein. Specifically, the two tube units 21 abut against each other. Gaskets 213 can be provided between the tube units 21 and the transversal plate 11. Please refer to FIG. 3C. Two blocking plates 214 are disposed in each of the through holes 211 of the tube units 21. The tube units 21 further has several intensifying plates 215, each of which connects one of the blocking plates 214 with its corresponding tube unit 21. The intensifying plates 215 are arranged parallel to an orientation of the through hole 211. More specifically, each intensifying plate 215 has a surface, which has a normal direction. And the orientation of the through hole is perpendicular to the normal direction. Please refer to FIG. 3 again. The pressure balancer 2 isolates the two through holes 211 from each other. The pressure balancer 2 includes a sleeve and a movable rod 221 that is movable in the sleeve. The movable rod 221 can be pushed corresponding to the water pressure in the through holes 211. As such, the area of the cross-section of the through holes 211 can be adjusted to balance the flow rate therein.

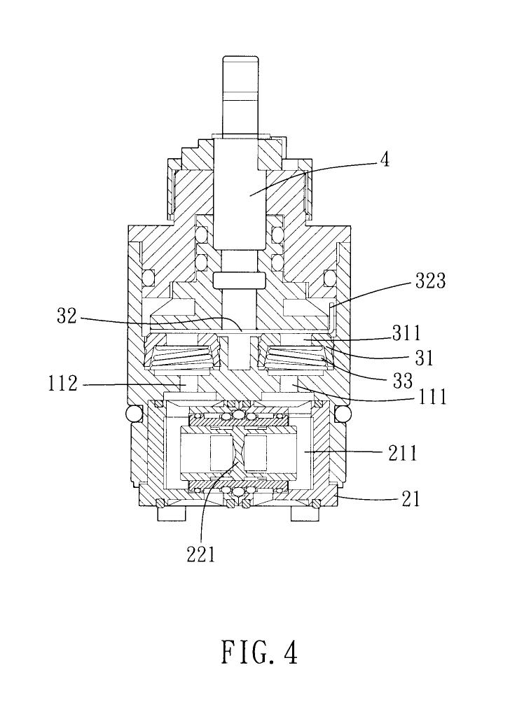

The mixing element 3 is disposed in the first chamber 12, and the mixing element 3 is adapted to regulate water to enter the first chamber 12 via the first and second passages 111 and 112 and to regulate the water in the first chamber 12 to flow to the third chamber 14. More specifically, the mixing element 3 includes two sealing gaskets 31, a throttle disc 32 and two resilient members 33. The sealing gaskets 31 abut against the transversal plate 11 respectively, and each sealing gasket 31 defines a through bore 311 communicated with one of the first and second passages 111 and 112. Please refer to FIG. 4, the sealing gaskets 31 are preferably tightly surrounded by the annular rims 113 respectively. The throttle disc 32 abuts against the sealing gaskets 31, and the throttle disc 32 is formed with a first slot 321 and a second slot 322. The resilient members 33 abut against the transversal plate 11 and the gaskets 31 respectively, so as to push the gaskets 31 to abut against the throttle disc 32 tightly.

Please refer to FIG. 3 and FIG. 4. The adjusting element 4 connects to the mixing element 3, and the adjusting element 4 is adapted to control a movement of the mixing element 3 so as to further adjust a mixing ratio of a flow rate in the first passage 111 to a flow rate in the second passage 112. Specifically, the adjusting element 4 and the throttle disc 32 are in a rotational operative relationship, so that the first and second slots 321 and 322 are controlled to selectively communicate the through bores 311 with the first chamber 12 respectively. More specifically, several protrusions 32 may be extended from the throttle disc 32 toward the adjusting element 4, while the adjusting element 4 may be correspondingly formed with several grooves 41 to engage with the protrusions 32. As such, the adjusting element 4 and the throttle disc 32 are in a rotational operative relationship, and the throttle disc 32 is rotated when the adjusting element 4 is turned.

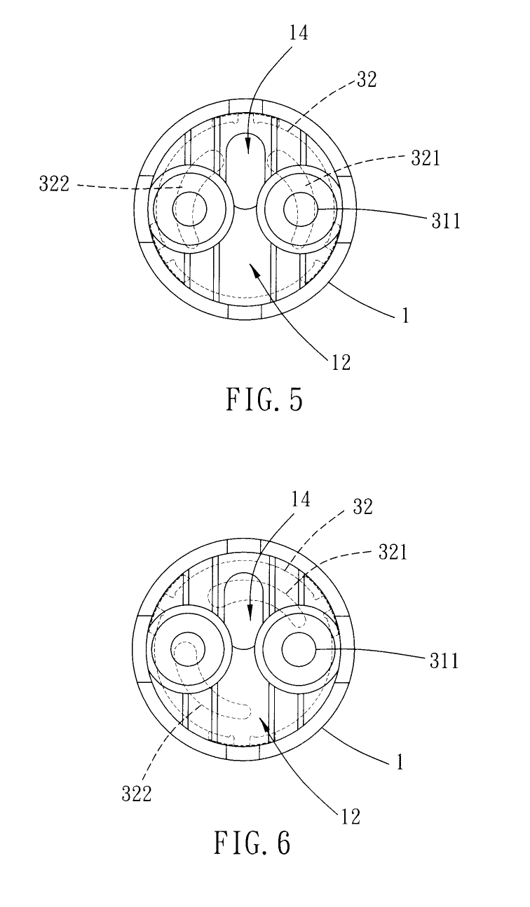

Please refer to FIG. 4. The through holes 211, the passages 111 and 112 and the through bores 311 define two inlet conduits which connects to two water sources respectively. Please refer to FIG. 5. The slots 322 communicate with the through bores 311 respectively, so that the water in the water source can be conducted into the first chamber 12 and then be evacuated via the third chamber 13. The mixing ratio is controlled when the adjusting element 4 is turned. Or, as shown in FIG. 6, one of the through bores 311 is blocked when the throttle disc 32 is further rotated. As such, the water in the first chamber 12 is totally provided by a single water source.

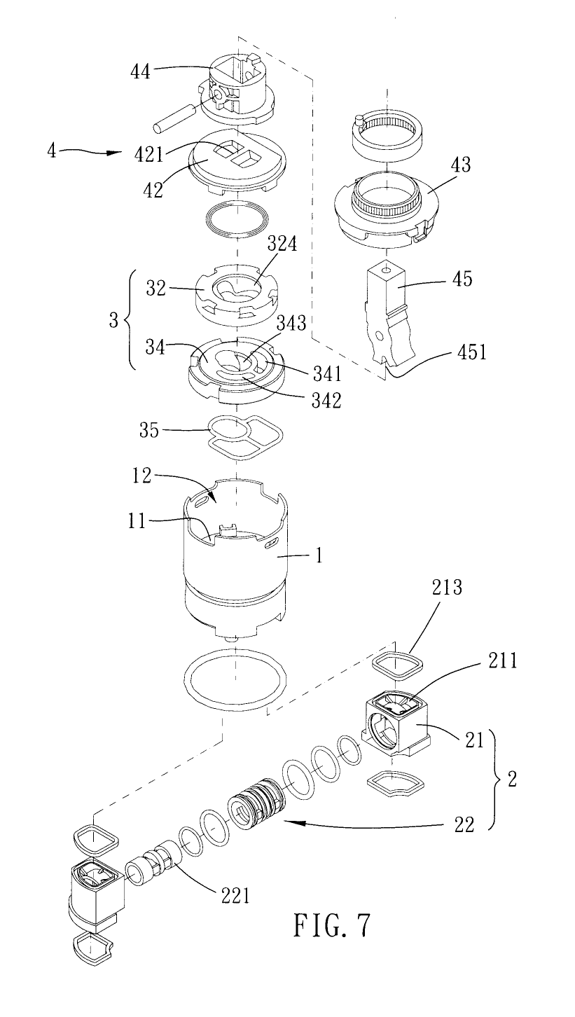

Please refer to FIG. 7 for another embodiment of the present invention. The mixing element 3 may includes a communicating disc 34 and a throttle disc 32. The communicating disc 34 is disposed in the first chamber 12 and abuts against the transversal plate 11, and the communicating disc 34 is formed with a first through bore 341, a second through bore 342 and a third through bore 343. A gasket 35 may be further provided between the communicating disc 34 and the transversal plate 11. The first through bore 341 is communicated with the first passage 111, the second through bore 342 is communicated with the second passage 112, and the third through bore 343 is communicated with the third chamber 14. The throttle disc 32 rotatably abuts against the communicating disc 34, and both discs 32 and 34 can be made of ceramics. The throttle disc 32 is formed with a mixing bore 324 which is communicated with the third through bore 343 all the time. And when the throttle disc 32 is rotated with respect to the communicating disc 34, the mixing bore 324 is selectively communicated with the first and second through bores 341 and 342.

The adjusting element 4 may include an engaging disc 42, a positioning ring 43, a rotational body 44 and a swayable rod 45. The engaging disc 42 engages with the throttle disc 32 in an operative relationship, and the engaging disc 42 is further formed with a socket 421. The positioning ring 43 is fixedly installed on the shell 1. The rotational body 44 is rotatably disposed in the positioning ring 43. The swayable rod 45 is pivoted to the rotational body 44. A lower end of the swayable rod 45 is formed with a plug 451 to plug in the sockets 421. As such, the swayable rod 45 can be swayed, and the engaging disc 42 and the throttle disc 32 are both driven to move linearly. Or, the swayable 45 can also be rotated. Thus the rotational body 44, the engaging disc 42 and the throttle disc 32 can all be driven to rotate.

What is claimed is:

1. A water mixer for a faucet, comprising:
a shell, having a transversal plate, the transversal plate having a first surface and a second surface, a first chamber being defined between the first surface and the shell, a second chamber and a third chamber being defined between the second surface and the shell, the transversal plate being formed with a first passage and a second passage, both of which communicate the first chamber with the second chamber, the third chamber being isolated from the second chamber, the third chamber being communicated with the first chamber;
a balance element, comprising a first tube unit, a second tube unit and a pressure balancer, the tube units being disposed in the second chamber, the first tube unit having a through hole communicated with the first passage, the second tube unit having a through hole communicated with the second passage, each tube unit having a lateral bore communicated with its through hole, the lateral bores of the tube units facing each other, a receiving space being defined between the lateral bores, the pressure balancer being movably disposed in the receiving space;
a mixing element, disposed in the first chamber, the mixing element being adapted to regulate water to enter the first chamber via the first and second passages and to regulate the water in the first chamber to flow to the third chamber;
an adjusting element, connecting to the mixing element, the adjusting element being adapted to control a movement of the mixing element so as to further adjust a mixing ratio of a flow rate in the first passage to a flow rate in the second passage.

2. The water mixer of claim 1, wherein the mixing element comprises two sealing gaskets and a throttle disc, the sealing gaskets abut against the transversal plate respectively, each sealing gasket defines a through bore communicated with one of the first and second passages, the throttle disc abuts against the sealing gaskets, the throttle disc is formed with a first slot and a second slot, the adjusting element and the throttle disc are in a rotational operative relationship, so that the first and second slots on the throttle disc are controlled to selectively communicate the through bores with the first chamber respectively.

3. The water mixer of claim 2, wherein two annular rims are axially extended from the first surface of the transversal plate, the annular rims surround one of the first passage and the second passage respectively, the sealing gaskets are tightly surrounded by the annular rims respectively.

4. The water mixer of claim 1, wherein the mixing element comprises a communicating disc and a throttle disc, the communicating disc is disposed in the first chamber, the communicating disc is formed with a first through bore, a second through bore and a third through bore, the first through bore is communicated with the first passage, the second through bore is communicated with the second passage, the third through bore is communicated with the third chamber, the throttle disc rotatably abuts against the communicating disc, the throttle disc is formed with a mixing bore, the mixing bore is selectively communicated with the first through bore and the second through bore, the mixing bore is communicated with the third through bore, the adjusting element and the throttle disc is in a rotational operative relationship, so that the throttle disc is controlled to selectively rotate with respect to the communicating disc.

5. The water mixer of claim 1, wherein two blocking plates are disposed in each of the through holes of the tube units, the tube units has several intensifying plates, each intensifying plate connects one of the blocking plates with its corresponding tube unit.

6. The water mixer of claim 5, wherein each intensifying plate has a surface, the surface of each intensifying plate has a normal direction, an orientation of the through hole is perpendicular to the normal direction.
